(19) United States
(12) Patent Application Publication
(10) Pub. No.: US 2011/0045237 A1
(43) Pub. Date: Feb. 24, 2011

(54) ELIMINATION OF ODOR CAUSED BY LASER-ETCHING LEATHER

(76) Inventor: Kimberly RIPLEY, Avon, OH (US)

Correspondence Address: BERENATO & WHITE, LLC, 6550 ROCK SPRING DRIVE, SUITE 240, BETHESDA, MD, 20817, US

(21) Appl. No.: 12/854,576

(22) Filed: Aug. 11, 2010

Related U.S. Application Data
(60) Provisional application No. 61/232,896, filed on Aug. 11, 2009.

(51) Int. Cl. B32B 3/10; C14C 9/00; B32B 3/30; C08J 7/00

(52) U.S. Cl. 428/131; 428/540; 428/156; 427/555

(57) ABSTRACT

Systems and methods for the elimination of odor caused by burned or laser-etching leather are provided. One method comprises the steps of providing a leather article with a burned-odor characteristic by laser-treating a side of the leather article; and treating the side of the leather article with an odor absorbent comprising zinc ricinoleate to eliminate the burned-odor characteristic.

### CROSS-REFERENCE TO RELATED APPLICATION(S)

This application claims the benefit of priority of provisional application 61/232,896, filed in the U.S. Patent & Trademark Office on Aug. 11, 2009 and entitled “Elimination of Odor Caused by Burning or Laser-Etching Laser,” the complete disclosure of which is incorporated herein by reference.

### FIELD OF THE INVENTION

The present invention relates to systems and methods for eliminating odor caused by laser-etching leather.

### BACKGROUND OF THE INVENTION

Laser etching is emerging as a new method for making materials such as leather, cloth, and various composite materials. In particular, laser etching has the ability to create unique designs that are not feasible or possible with alternative technologies such as embossing. Because the laser etching process is primarily a digital process, unique designs and patterns can be created from graphic images obtained through different sources. Such graphic images can be drawn from scratch in programs such as Adobe Illustrator, downloaded from the Internet, or scanned from printed copies. The designs and patterns can include graphic images, logos, alphanumeric codes, repeating patterns of graphics, random patterns of graphics, perforations, fake perforations (where the laser does not fully penetrate the lazed object), and any combination of these designs.

As such, new and unique aesthetics can be created for automobile interiors, furniture, apparel, etc. by etching and perforating with the laser etching process. The process can be performed very quickly and has the added advantage of being able to produce a single custom design or millions of units of the same design quickly and efficiently. The number of different designs and patterns that can be created is essentially limited by the imagination of the designer.

However, the laser etching process has a drawback when applied to leather: after lazing patterns, and particularly perforations, in the leather, the odor of the lazed leather article may be so sharp and distinctive that it can be considered offensive. It is believed that the generation of the offensive odor is caused by the chemical effect of burning the leather. Conventional methods for reducing the odor of lazed leather, such as through chemicals or UV exposure, have achieved limited to no success. Thus a need exists for the elimination of odor caused by burning or laser-etching leather.

### SUMMARY OF INVENTION

According to one aspect of the invention, a method is provided for the elimination of odor caused by laser-etching leather, the method comprising the steps of: providing a leather article with a burned-odor characteristic by laser-treating a side of the leather article; and treating the side of the leather article with an odor absorbent comprising zinc ricinoleate to eliminate the burned-odor characteristic.

Another aspect of the invention relates to a system for producing a laser-treated article with a reduced odor, the system comprising a conveyor belt, a first station comprising a laser for producing a leather article with a burned-odor characteristic by laser-treating a side of the leather article; and a second station comprising an odor-absorbent applicator for spraying the laser-treating side of the leather article with an odor absorbent comprising zinc ricinoleate to eliminate the burned-odor characteristic. In the system, the conveyor belt moves the leather article to the first station and from the first station to the second station.

Another aspect of the invention relates to an article with a reduced burned-odor characteristic, the article comprising a burned article treated with an odor absorbent comprising zincricinoleate.

Other aspects of the invention, including apparatus, systems, methods, kits and the like which constitute part of the invention, will become more apparent upon reading the following detailed description of the exemplary embodiments and viewing the drawings.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a flow diagram according to an embodiment of the invention;

FIG. 2 is a perspective view of a vehicle seat article having a headrest and a seat back with laser perforations according to an embodiment of the invention;

FIG. 3 is a schematic view of a system for marking the surface of an article and treating the article with an odor absorbent according to an embodiment of the invention;

FIG. 4 is a schematic view of a system for marking the surface of an article and treating the article with an odor absorbent according to another embodiment of the invention; and

FIG. 5 is a schematic view of a system for marking the surface of an article and treating the article with an odor absorbent according to an embodiment of the invention.

### DETAILED DESCRIPTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

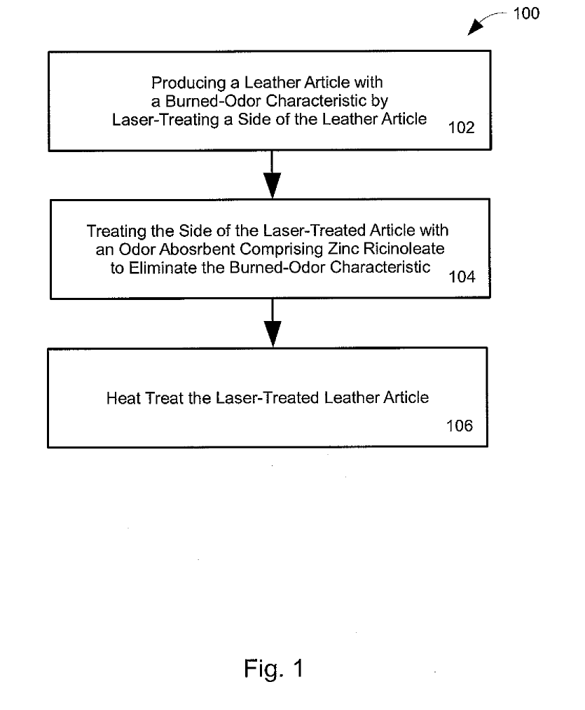

In the method 100 illustrated in FIG. 1, a leather article with a burned-odor characteristic is provided 102. Laser-treatment may comprise laser marking the surface of the article, for example reproducing one or more graphic designs onto the article surface. In the course of laser marking (also referred to as laser etching or lasing), a laser beam causes a change to the article surface that is visually perceptible to the naked-eye. This “change” may involve the removal, ablation, or etching of a coated or uncoated article surface. The visually perceptible change is typically in the form of a recess of a depth that extends partly through the article or article coating, without cutting entirely through the article or leather component of the article or penetrating partially or fully through the article in the case of laser perforations. (This usual operation is not intended to exempt from the scope of the invention the use of the laser for separate cutting operations.) The recess may be configured as a channel, groove or trench, cavity, or other depression. Alternately, the visually perceptible change may be limited to the surface only, or a color change to a dye contained in the substrate or a coating applied to the article surface.

Alternatively, or in addition to laser-marking a design on the surface of the article, laser-treating the article may comprise perforating the article. Laser-perforating an article creates one or more small holes in an article. Each perforation may extend completely through the depth of the article.

The article may be a piece of leather, or alternatively, the article may comprise a different material, such as vinyl, plastic, rubber, or a reaction injection molded article. Some articles may comprise both leather and non-leather components. The article can obtain a burned-odor characteristic through a variety of ways. In FIG. 1, the article, a leather article, obtains a burned-odor characteristic through burning via laser marking. Specifically, a laser may etch indentions in the leather and/or create perforations in the leather. Alternatively, the article may be burned via branding. Specifically, a hot iron or other piece of metal may stamp a graphic, such as initials or an insignia, onto the article, thereby burning it.

Typically when leather or other materials are burned, such as during laser-marking, the materials retain a strong smell, i.e. a burned-odor characteristic. In particular, burned leather may retain a strong commercially unacceptable odor for some time after it is laser treated. After the article is laser-treated, the article is treated with an odor absorbent comprising zinc ricinoleate to eliminate the burned-odor characteristic 104. One or both sides of the leather article can be sprayed with the odor absorbent, or the article can be soaked in odor absorbent for a predetermined period of time. In some applications, the article is pre-treated with the odor absorbent before it is laser-treated.

The laser scribing and odor-reduction and/or elimination (also referred to herein as deodorizing) operations may be performed in any order or simultaneously. In the embodiment depicted in FIG. 1, an article is first subjected to a lazing operation 102, and then deodorized 104. Alternatively, the article may be pre-treated with a deodorizing composition (i.e. the odor absorbent) prior to or simultaneously with the burning operation. Although not shown in FIG. 1, other operations such as cooling, drying and/or colorizing may be included.

All or less than all of the article surface may be laser marked and/or treated with odor absorbent. The surface of the article may be treated with the odor absorbent, such as through spraying, or the entire article may be treated, such as through soaking in a deodorizing bath for a predetermined period of time (for example 1-10 seconds). The odor absorbent comprises zinc ricinoleate, the zinc salt of ricinoleic acid. The odor absorbent may also comprise additional elements, such as sodium iminodisuccinate and water.

Once the article is treated with an odor absorbent, the article is optionally subjected to a heat treatment 106. For example, the article may pass through a heating chamber or pass under a heating lamp for a predetermined period of time. Heat treating the article may further eliminate the burned odor characteristic of the laser-treated article.

A number of articles may be subjected to the method 100 in quick succession, such as on a production line. Alternatively, individualized articles may be produced one-at-a-time. A computer controller used to control the marking or lazing process may facilitate the transition from a one-off product to a series of identically-marked products.

Methods of laser-marking different materials are set forth in U.S. Pat. No. 5,990,444 issued Nov. 23, 1999 entitled “Laser Method and System for Scribing Graphics, and PCT Application No. PCT/US2008/007316 filed Jun. 12, 2008 entitled “High Speed and High Power Laser Etching of Building Products” and PCT/US2009/02546 filed Apr. 24, 2009, entitled “Combination Extrusion and Laser-Marking System, and Related Method” which are hereby incorporated by reference in their entirety. The teachings of the U.S. patent and the International patent applications with respect to lasing may be adapted by those skilled in the art to laser mark leather goods.

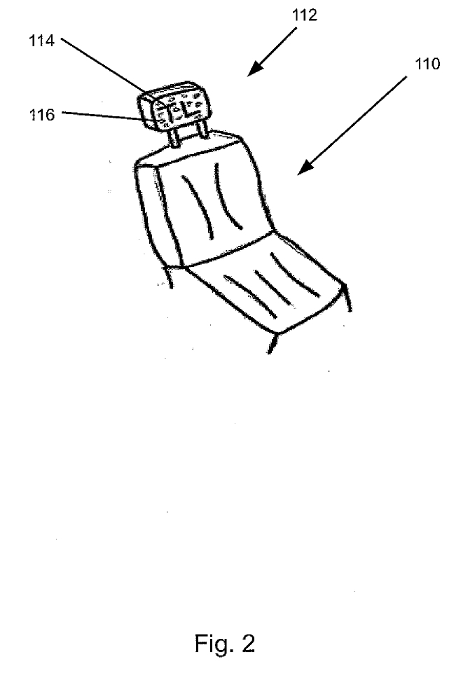

Leather goods encompassed by embodiments of the invention include automobile interior products such as seats, headrests, and door panels; clothing items such as jackets, belts, shoes, purses, wallets, and pocketbooks; business-related items such as briefcases and personal organizer holders; household and residential and commercial furniture such as sofas and chairs; and other items. An example of such a laser-marked leather article is illustrated in FIG. 2, which shows a laser-treated article, i.e. a leather vehicle seat 110 with a leather headrest 112. The leather headrest 112 is laser-marked with the initials 114 “TL.” Alternatively, the initials 114 and/or other graphic designs may be etched or otherwise laser-treated onto the article. Additionally, the headrest 112 has laser perforations 116. The perforations 116 could be fully penetrating or partially penetrating the leather. Notably, a preferred embodiment of the invention utilized laser etching to provide a combination of surface etching and perforation passing through the article to provide a unique, desired design.

Graphic designs referred to herein may encompass decorative and artistic designs. The graphic design may include repeating patterns such as diamond, hounds tooth or chevron patterns, or non-repeating graphic designs, such as floral designs. The graphics may be simple geometric shapes or highly complex shapes and/or alphanumeric information, such as the initials “TL” of FIG. 2. As discussed in greater detail below, exemplary embodiments of the invention permit the marking of advanced, highly aesthetic designs to allow the manufacture of premium products in an economical manner for high output industrial production.

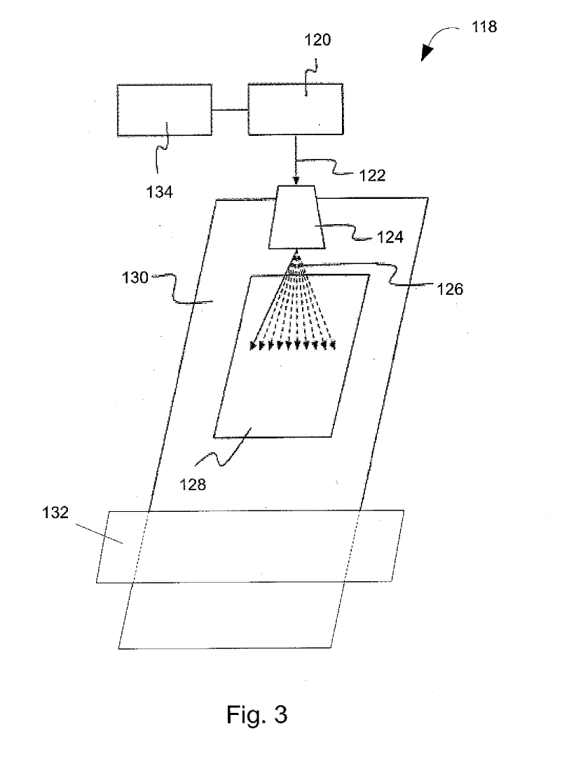

FIG. 3 is a schematic view of a system 118 for marking the surface of an article and treating the article with an odor absorbent using a laser. The laser 120 comprises a high-power high-speed laser. The laser beam 122 generated by the laser 120 is coupled to a scanning head 124, which includes a controllable, movable relatively light-weight coated mirror that is capable of scanning the laser output at a relatively high speed. The laser output 126 can be scanned across the work piece 128 on a working surface 130.

The system 118 further comprises an odor absorbent applier 132, shown in FIG. 3 as a bath or soaker. After the article 128 is laser-treated, the article is directed through the odor absorbent bath 132 and soaked with odor absorbent comprising zinc ricinoleate. The article 128 may be completely or partially immerged in the odor absorbent bath 132. Of course, the article 128 may be sprayed on one or both sides with a spray mechanism utilizing the zinc ricinoleate substance.

The system 118 also includes a controller 134. Control information for controlling the laser 120 and/or the odor absorbent applier 132 may be stored in advance in the controller 134. The stored control information may be linked to one or many different graphics, e.g., patterns. The controller 134 is capable of keeping up with the high scan speeds produced by the lightweight mirrors and making the necessary power changes at the specified speed. To create fine resolution graphics, the controller makes those power changes at high rates, such as every few millimeters of beam scan. The scan speed of the laser will determine the amount of power changes within the graphic. The type (e.g., complexity and intricacy) and depth of the graphic will also influence how it is marked on the substrate. The stored control information may also include a duration for the immersion in the odor absorbent bath 132 and/or a volume of odor absorbent to be sprayed onto the article 128. The amount of odor absorbent needed for each application may vary, and may depend on, for example, the size of the article to be deodorized, the size of the laser-treated mark, or the strength of the odor absorbent.

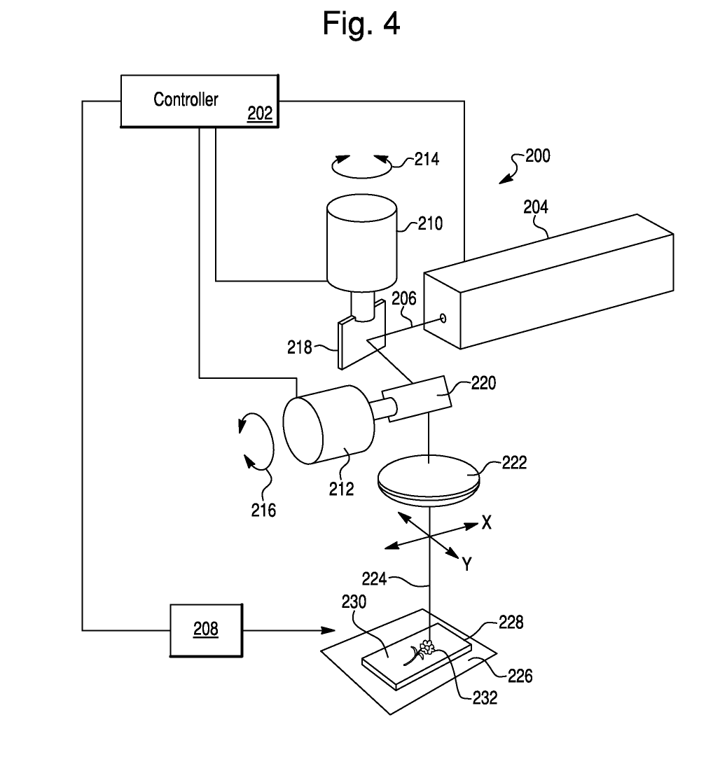

FIG. 4 illustrates another embodiment of a system for marking work pieces, in particular leather articles. The system 200 includes a laser 204 for generating a laser beam 206 in a direction of a mirror system manipulated by controller 202. The illustrated mirror system 200 includes an x-axis mirror 218 rotatably mounted on and driven by an x-axis galvanometer 210. The x-axis galvanometer 210 is adapted to rotate in the direction of 214 and cause the rotation of the x-axis mirror 218. Rotation of the x-axis mirror 218 while the laser beam 206 is incident on the mirror 218 causes the laser beam 206 to move along the x-axis of the article 228.

The controller 202 controls the output of a power source (not shown in FIG. 4) to control the x-axis galvanometer's 210 rotation of the x-axis mirror 218. The laser beam 206 is deflected by the x-axis mirror 218 and directed toward a y-axis mirror 220 rotatably mounted on y-axis galvanometer 212. The y-axis galvanometer 212 is adapted to rotate and cause rotation of the y-axis mirror 220. Rotation of the y-axis mirror 220 causes movement of the laser beam 206 incident on mirror 220 along the y-axis of the article 228. The controller 202 controls the output of the power source (not shown in FIG. 4) delivered to y-axis galvanometer 212 for controlling rotation of the y-axis galvanometer 212 and mirror 220.

The laser beam 206 is deflected by the y-axis mirror 220 and directed through a focusing lens 222 adapted to focus the laser beam 206. The lens 222 may be a multi-element flat-field focusing lens assembly, which optically maintains the focused spot on a flat plane as the laser beam 224 moves across the article 228 to scribe or mark a graphic 232. The lens 222, mirrors 218, 220 and galvanometers 210, 212 can be housed in a galvanometer block (not shown).

The apparatus 200 further includes a working surface 226 which can be a solid substrate such as a table, or even a fluidized bed. A work piece (e.g., leather good) 228 is placed on the working surface 226. The work piece 228 includes a viewable, laser-markable surface 230 to be laser marked. The working surface 226 can be adjusted vertically to adjust the distance from the lens 222 to the laser-markable surface 230 of the work piece 228. The laser beam 206 is directed by the mirrors 218, 220 against the laser-markable surface 230 of the work piece 228. Usually the laser beam 224 is directed generally perpendicular to the laser-markable surface 230, but different graphics can be achieved by adjusting the angle between the laser beam 224 and the laser-markable surface 230, for example, from about 45° to about 135°.

Relative movement between the laser beam 224 in contact with the laser-markable surface 230 of the work piece 228 causes a graphic 232 to be scribed on the laser-markable surface 230. The movements and timing of the mirrors 218, 220 and the power of the laser beam 206 are controlled by the controller 202 to scribe the specific desired graphic 232. As referred to herein, relative movement may involve movement of the laser beam 224 (e.g., using the mirror system) as the work piece 228 remains stationary, movement of the work piece 228 while the laser beam 224 remains stationary, or a combination of simultaneous movement of the laser beam 224 and the work piece 228 in different directions and/or at different speeds.

The controller 202 can control the galvanometers 210, 212 and mirrors 218, 220 and the power output of the laser beam 206 to form the graphic 232 on the laser-markable surface 230 of the work piece 228 at the appropriate power and movement velocity for high throughput. The power and speeds should be controlled to avoid any undesirably consequences of over-treatment, such as complete carbonization, burn-through and/or melting of the work piece.

The controller 202 can also be used to control the application of the odor absorbent by the odor absorbent applier 208. As shown in FIG. 4, a graphic 232 is applied to the article first, and then the odor absorbent applier 208 treats the article with the odor absorbent. For example, a graphic 232 can be laser-treated onto the article 228 by the laser 224, and then odor absorbent comprising zinc is sprayed onto the graphic 232. The applier 208 may spray the odor absorbent onto one or both opposite surfaces of the article 228.

The system 200 can also include a tank for supplying odor absorbent to the applier 208, or alternatively for directly immersing the burned article 230 in odor absorbent. The amount of odor absorbent applied to the article can be controlled by the controller 202 or by other means. For example, the controller 202 may control the volume of the odor absorbent applied to the article 228, such as through a spraying process, or the amount of time the article is immersed in the odor absorbent. Once the article 228 is treated by the applier 208, the article exhibits a substantially reduced burned-odor characteristic—that is the burn smell has been reduced or even eliminated from the article 228.

The controller 202 can be a personal computer system. Computer hardware and software for carrying out the embodiments of the invention described herein may be any kind, e.g., either general purpose, or some specific purpose such as a workstation. The computer may be a Dual Core or Pentium® class computer, running Windows XP®, Windows Vista ®, or Linux®, or may be a Macintosh® computer. The computer may also be a handheld computer, such as a PDA, cell phone, or laptop. The programs may be written in C, or Java, Brew or any other programming language. The programs may be resident on a storage medium, e.g., magnetic or optical, of, e.g., the computer hard drive, a removable disk or media such as a memory stick, or SD media, flash drive, or other removable medium. The programs may also be run over a network, for example, with a server or other machine sending signals to one or more local machines, which allows the local machine(s) to carry out the operations described herein.

It should be understood that other embodiments of the invention may be carried out using various other laser systems having alternative layouts and components to those shown in FIGS. 3 and 4. For example, the laser beam can first pass through the focusing lens and then directed to the scan mirror in a typical post objective scanning architecture.

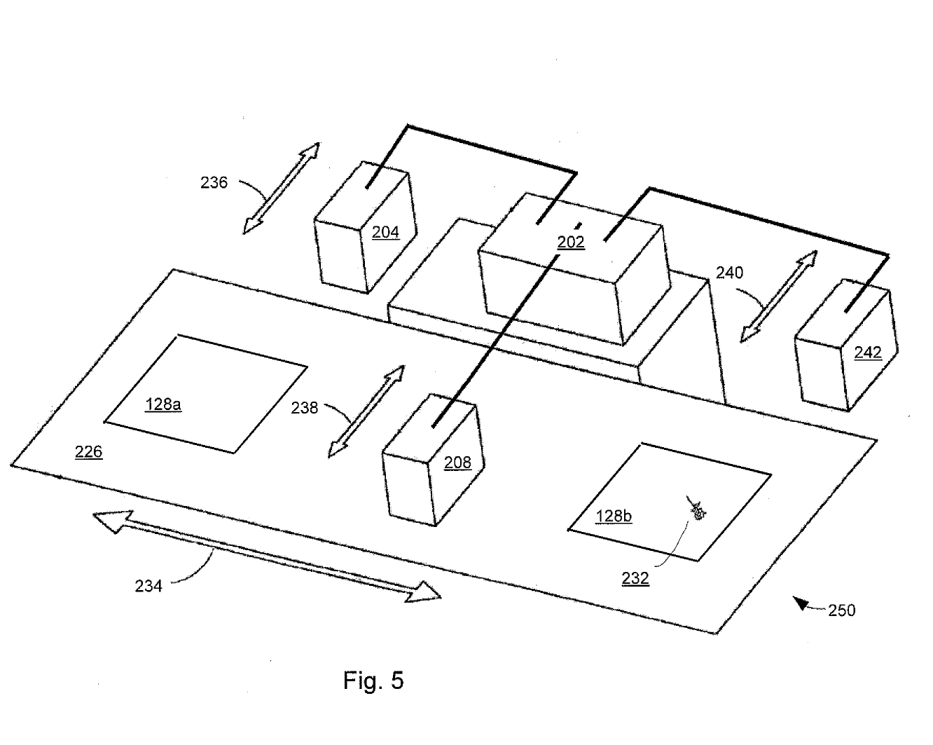

FIG. 5 is a schematic view of a system for marking the surface of an article and treating the article with an odor absorbent according to an embodiment of the invention. As shown in FIG. 5, the system 250 comprises a working surface 226 (i.e. conveyor belt), a first station 204, a second station 208, and a third station 242. The first station 204 comprises a laser for producing a leather article with a burned-odor characteristic by laser-treating a side of the leather article. The second station 208 comprises comprising an odor-absorbent applicator for spraying the laser-treating side of the leather article with an odor absorbent comprising zinc ricinoleate to eliminate the burned-odor characteristic. In the instance that the leather article is perforated by the laser, the article is sprayed on both or opposite side to most effectively eliminate odor. The third station comprises a heating station for heat-treating the leather article to further eliminate the burned odor characteristic.

A controller 202 is in communication with the first station 204, the second station 208, and the third station 242. The controller 202 can be configured to automatically control the laser, the odor absorbent applicator, and the heat-treatment. During operation of the system 250, the laser in the first station 204 can move back and forth across the width of the conveyor belt 226 in the direction of arrow 236. Similarly, the odor absorbent sprayer at the second station 208 can move back and forth across the width of the conveyor belt 226 in the direction of arrow 238, and the heating station 242 can move back and forth across the width of the conveyor belt 226 in the direction of arrow 240. The first station 204, the second station 208, and the third station 242 may operate in tandem, or they may operate independently of each other. In other words, the laser may operate in coordinate with the odor absorbent applicator, or independent of the applicator.

Notably, the second station 208 of the system 250 may comprise an odor absorbent spray assembly that applies odor absorbent material to opposite sides of the articles on the conveyor belt 226. Applying odor absorbent material to opposite sides of the article is particularly effective when the article is laser-treated to include perforation therethrough.

As shown in FIG. 5, two work pieces, shown as leather articles 128a and 128b, are positioned on the conveyor belt. The leather articles 128a, 128b move on the working surface 226 in the direction shown by arrow 234 (i.e. right to left or left to right). The first leather article 128a is ready to be laser-treated. The second leather article 128b comprises a laser-treated leather article treated with an odor absorbent comprising zinc ricinoleate. The leather article 128b has a graphical laser-etching 232 on its surface.

As shown in FIG. 5, leather articles can progress in a substantially horizontal left-to-right direction, first passing under the laser of the first station 204, second passing under the odor absorbent applicator of the second station 208, and finally passing under the heat treatment of the third station 242. In one alternative, the second station 208 includes both an odor absorbent applicator and a heat treatment apparatus for faster production.

The laser-treated designs include a variety of laser etched graphics, perforations and simulated perforations. Each of the files used to laser etch the designs may only comprise part of the overall design, or alternatively comprise a combination of multiple designs within the same file. The laser parameters required to provide the proper aesthetic depend upon several factors, such as the type of leather, the thickness of the leather and the particular graphic design and intensity desired. To laser etch a graphic or logo on leather, enough energy must be used to impart a clear, crisp image without undesirable defects, such as may be caused by applying too much energy so that burning or melting of the leather occurs. Laser etching and/or perforating typically involves working with vector files such as dxf format. However, rastor files can also be used for creating laser etched or perforated leather.

Perforating leather requires a much greater amount of energy to completely burn through the leather to form the holes within the graphic, such as circles or squares. Leather can be perforated on the front or back of the material and one pass or multiple passes can be performed in order to attain the right look. This can affect the size and shape of the individual holes. The final design includes simulated perforations, which have the appearance of real perforations but do not extend completely through the leather. The amount of energy density per unit time must be carefully controlled to remove a sufficient amount of the material to form depth without completely penetrating the leather. The thickness of the leather will also determine how much depth can be employed. Hence, the amount of laser power needed to provide an acceptable design will be determined by a number of factors including the nature of the substrate, the type of graphic, and the degree of perforations.

For high speed laser marking operations, about 500 watt to about 5,000 watt or higher power lasers may be coupled to ultra high speed scan heads capable of 50 meters per second or greater speeds offer attractive unit manufacturing costs and economics. Laser scan speeds of 10-50 meters per second can etch graphic patterns in time frames measured in seconds per square foot and unit costs measured in pennies per square foot. As referred to herein, “speed” is the speed of the laser output (e.g., beam) relative to the surface of the material. Relative speed may be imparted by moving the laser output while maintaining the material stationary, or by moving the material while maintaining the laser output stationary, or by simultaneously moving the laser output and material in different directions and/or at different rates.

In order to provide a laser system with high scan speeds, e.g., ranging from 30-50 meters/second, in certain high speed embodiments, lightweight high technology mirror systems with high temperature coatings as commercially available are used. An exemplary commercially available lightweight high technology mirror system is ScanLab AG, Model PowerSCAN33 Be, 3-axis Galvanometer scanner with 33 mm Be Mirrors. The high temperature coating is believed to be a physical vapor deposited alloy. The lightweight beryllium substrate is coated with materials allowing the mirror surface to reflect over 98% of the CO₂ wavelength, 10.6 microns. The lightweight high technology mirror systems allow the galvanometers (or “galvos” for short) to move the laser output (e.g., beam) in a repeatable but efficient fashion over the substrate surface. The scan speed of such a laser system is surprisingly an order of magnitude higher than the laser scan speeds achieved with either linear drives or conventional galvo mirrors. Using such a lightweight mirror system, laser scan speeds in excess of 65 meters per second have been achieved, compared to maximum scan speeds of 4-5 meters per second with conventional laser engraving technology.

The odor absorbing material may be applied to the leather article using any suitable technique, such as spraying, dipping or coating. According to one exemplary embodiment of the invention, the odor absorbing material includes a salt, such as a zinc salt, of ricinoleic acid. A particularly useful odor absorbing composition is disclosed in U.S. Patent Application Publication No. 2009/0092568 to Mabrouk entitled “Deodorizing Composition and Method of Forming Thereof” (hereinafter “the ′568 publication”) the disclosure of which is incorporated herein by reference.

Generally, the odor absorbing composition useful in the invention includes a zinc salt of ricinoleic acid and at least one amino-functional amino acid, salt and/or derivative thereof. In a particularly advantageous composition, the composition includes a zinc salt of ricinoleic acid, a solubility promoter including at least sodium iminodisuccinate, water, and optionally other ingredients such as perfumes and antifungal agents and/or bactericides. Generally, the composition may include, for example, about 0.1 to about 60 percent by weight, preferably about 2 to about 20 percent by weight zinc ricinoleate, and about 1 to about 30 percent by weight, preferably about 2 to about 10 percent by weight of the sodium iminodisuccinate, based on the total weight of the composition. The zinc ricinoleate is preferably completely solubilized in water, yet the solution exhibits low foaming and friability.

The odor-absorbing material of the invention may be in the form of a spraying liquid, a liquid capable of being coated or otherwise applied to a surface, opposite surfaces, and even a vertical surface depending upon its physical properties, a gel or solid tablet, a powder, or any other form. The odor absorbing composition may be applied to the leather article after laser etching through a dipping process in which the leather article is saturated with the composition. Saturation may be necessary to assure that the entirety of the laser-treated surface is treated with the odor absorbing composition. The treated article may include a residue of the odor-absorbing material subsequent to treatment.

The zinc salts of ricinoleic acid are commercially available from various manufacturers under trade names such as TEGO® Sorb PY 88 from Goldschmidt Chemical Corporation of Hopewell, Va. An exemplary 34 percent aqueous solution of sodium iminodisuccinate is available from Bayer under the trade name BAYPURE CX. The water may be deionized, filtered, demineralized, or alternatively tap water, although preferably with a sufficiently low degree of hardness as not to impede the effectiveness of the composition.

Additional solubilizing agents that optionally may be included in the composition include nonionic and ionic surfactants. The solubility agents may be present in amount of, for example, 0 to about 20 percent by weight. Other components that may be added to the composition include alcohols such as ethanol and isopropyl alcohol, additional odor control agents such as zeolites, carbon odor-controlling agents, sodium bicarbonates, antimicrobial agents, antiperspirant agents, perfume agents, and/or “salt acids” such as skin protectants, emollients and moisturizers.

The compositions can be prepared by mixing the components in any suitable manner and in any particular order. Elevated temperatures (e.g., about 90° C.) may be used during mixing to facilitate the formation of solution, as described in the ′568 publication.

The herein disclosed invention provides a breakthrough in resolving a problem associated with the use of laser etched leather in automotive, residential, commercial, apparel and other applications. Although lazing methods have been known in the industry for several years, manufacturers have been reluctant to use laser-treated articles, in particular laser-treated leather articles, due to the strong odor. Other chemical products such as perfume type products seem to only mask the odor from the burnt leather and not eliminate it.

Although embodiments of the invention have been described above in connection with laser-etching, the principles of the invention may apply to other methods of decorating leather such as burning designs in the leather with hot tools or branding equipment.

### EXAMPLES

Experimental trials involved lazing perforations in leather and observing the odor from a first sample not treated, and a second sample sprayed with Zorbx on the back of the leather, and a third sample sprayed with Zorbx on the front and back of the leather. In a most surprising result, it was found that the second and third samples sprayed with the Zorbx compound exhibited no offensive odor immediately after application, whereas the untreated laser-perforated first sample had a very offensive odor that existed even several days after it was produced. Spraying the leather with Zorbx prior to lazing also revealed significant improvement in reducing the burnt leather odor (i.e. burned-odor characteristic). Furthermore, experiments were conducted with lazing graphic images and/or perforations on vinyl, rubber, plastic and reaction injected molded parts. It was noted that all these materials demonstrated an offensive burnt odor after lazing. Surprisingly, however, it was found that treating these materials with Zorbx offered a significant improvement in odor reduction vs. not treating these materials with Zorbx.

The foregoing detailed description of the certain exemplary embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Although only a few embodiments have been disclosed in detail above, other embodiments are possible and the inventors intend these to be encompassed within this specification and the scope of the appended claims. The specification describes specific examples to accomplish a more general goal that may be accomplished in another way. Modifications and equivalents will be apparent to practitioners skilled in this art and are encompassed within the spirit and scope of the appended claims and their appropriate equivalents. This disclosure is intended to be exemplary, and the claims are intended to cover any modification or alternative which might be predictable to a person having ordinary skill in the art.

Only those claims which use the words “means for” are to be interpreted under 35 USC 112, sixth paragraph. Moreover, no limitations from the specification are to be read into any claims, unless those limitations are expressly included in the claims.

What is claimed is:

1. A method for producing a burned article with a reduced odor, the method comprising:
producing a leather article with a burned-odor characteristic by laser-treating a side of the leather article; and
treating the side of the leather article with an odor absorbent comprising zinc ricinoleate to eliminate the burned-odor characteristic.

2. The method of claim 1, further comprising treating a second side of the leather article with an odor absorbent comprising zinc ricinoleate to eliminate the burned-odor characteristic.

3. The method of claim 1, further comprising heating the leather article to further eliminate the burned-odor characteristic.

4. The method of claim 1, wherein laser-treating the article comprises marking the surface of the article with a laser.

5. The method of claim 1, wherein laser-treating the article comprises modifying the depth of the article with a laser.

6. The method of claim 5, wherein laser-treating the article comprises laser-perforating the article.

7. The method of claim 1, wherein treating the side of the leather article with an odor absorbent comprises spraying the side of the leather article with an odor absorbent.

8. The method of claim 1, wherein zinc ricinoleate comprises 0.1 to 60 percent of the odor absorbent by weight.

9. The method of claim 8, wherein zinc ricinoleate comprises 2 to 20 percent of the odor absorbent by weight.

10. The method of claim 1, wherein the odor absorbent further comprises sodium iminodisuccinate and water.

11. The method of claim 10, wherein sodium iminodisuccinate comprises 1 to 30 percent of the odor absorbent by weight.

12. The method of claim 11, wherein sodium iminodisuccinate comprises 2 to 10 percent of the odor absorbent by weight.

13. A burned article with a reduced burned-odor characteristic, the article comprising:
a laser-treated leather article treated with an odor absorbent comprising zincricinoleate.

14. The article of claim 13, wherein the laser-treated leather article comprises an article laser-marked on a surface of the article.

15. The article of claim 13, wherein the laser-treated leather article comprises a laser-perforated article.

16. The article of claim 13, wherein the laser-treated leather article is heat-treated.

17. The article of claim 13, wherein zinc ricinoleate comprises 2 to 20 percent of the odor absorbent by weight.

18. The article of claim 13, wherein the odor absorbent further comprises sodium iminodisuccinate and water.

19. A system for producing a laser-treated article with a reduced-odor, the system comprising:
a conveyor belt;
a first station comprising a laser for producing a leather article with a burned-odor characteristic by laser-treating a side of the leather article; and
a second station comprising an odor-absorbent applicator for spraying the laser-treating side of the leather article with an odor absorbent comprising zinc ricinoleate to eliminate the burned-odor characteristic,
wherein the conveyor belt moves the leather article to the first station and from the first station to the second station.

20. The system of claim 19, further comprising:
a third station comprising a heating station for heat-treating the leather article to further eliminate the burned odor characteristic.
